(19) United States
(12) Patent Application Publication
(10) Pub. No.: US 2015/0308851 A1
(43) Pub. Date: Oct. 29, 2015

(54) ROUTE EXTRACTION METHOD, AND ROUTE GRAPH GENERATION METHOD

(71) Applicant: FUJITSU LIMITED, Kawasaki-shi (JP)

(72) Inventors: Hiroaki Morikawa, Kawasaki (JP); Hiroya INAKOSHI, Tama (JP); Tatsuya Asai, Kawasaki (JP); Junichi Shigezumi, Kawasaki (JP)

(21) Appl. No.: 14/645,086

(22) Filed: Mar. 11, 2015

(30) Foreign Application Priority Data
Apr. 23, 2014 (JP) 2014-089571

(51) Int. Cl. G01C 21/36

(52) U.S. Cl. CPC G01C 21/3676

(57) ABSTRACT

A route extraction device includes a processor that executes a process. The process includes, when extracting, for combination with an identified route out of plural routes, a route from the other routes in the plural routes, performing control that increases extraction probability according to distribution density of the other routes.

### CROSS-REFERENCE TO RELATED APPLICATION

This application is based upon and claims the benefit of priority of the prior Japanese Patent Application No. 2014-089571, filed on Apr. 23, 2014, the entire content of which is incorporated herein by reference.

### FIELD

The embodiments discussed herein are related to a route extraction method, and a route graph generation method.

### BACKGROUND

Hitherto, technology has existed that performs analysis related to routes of moving bodies as spatial information analysis. For example, technology exists that performs an OD (O=“origin”, D=“destination”) search that finds routes having specified localities as origins or destinations, from plural track data that are actual observation data. Technology also exists that analyzes OD frequencies indicating combinations of outset localities and destination localities (such as (Shinjuku Station to Shibuya Station), or (Shinagawa Station to Ikebukuro Station) for example) appearing a specific number of times (for example, 10 times) or more, from plural track data. Technology also exists that finds partial routes, such as a route passing through Shinagawa Station→(Yamanote Line Outer Circle)→Ikebukuro Station, from track data. Technology also exists that analyzes frequent partial routes representing partial routes appearing a specific number of times (for example, 10 times) or more in track data. In such route analysis, when the route to be analyzed is predetermined by a road network, map data, or the like, appropriate analysis results can be obtained by mapping the track data onto routes.

We consider here cases of route analysis in which people, acting as moving bodies, are the focus. Track data representing movement of people may, for example, be acquired as a series of position data, periodically position-measured as a latitude and longitude (a position-measurement point) by a GPS (global positioning system) sensor installed in a mobile phone, smart phone, or the like. WiFi or the like may also be employed for acquiring position data. Movement of people is not limited to movement along a road, train tracks, etc.; sometimes free movement occurs through open spaces in, for example, exhibition halls and the like. Namely, sometimes track data is also acquired for spaces in which routes are undetermined. In methods of performing route analysis on track data associated with predetermined routes such as road networks, or map data, route analysis cannot be performed on track data for spaces in which routes are undetermined.

Technology therefore exists in which a target-analysis range is apportioned to plural regions (a mesh) of a specific surface area, and position-measurement points indicating respective position data included in the track data is associated with the mesh. In such technology, the OD (origin, destination) in the route analysis appears as a combination of a mesh pair associated with position-measurement points indicating the OD, and the routes appear as track data passing through a mesh series.

### RELATED PATENT DOCUMENTS

Japanese Laid-Open Patent Publication No. 2001-125882
Japanese Laid-Open Patent Publication No. 2013-54640

### SUMMARY

According to an aspect of the embodiments, a route extraction method includes, by a processor, when extracting, for combination with an identified route out of plural routes, a route from the other routes in the plural routes, performing control that increases extraction probability according to distribution density of the other routes.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an example of route graph generation by track combination;

FIG. 2 is a block diagram illustrating a schematic configuration of a route graph generation system including a route graph generation device according to a first and a second exemplary embodiment;

FIG. 3 is a functional block diagram of a route graph generation device according to the first exemplary embodiment;

FIG. 4 is a diagram illustrating an example of tracks;

FIG. 5 is a diagram for explaining identification of commonizable locations;

FIG. 6 is a diagram for explaining identification of commonizable locations;

FIG. 7 is a table for explaining calculation of awarded points based on densities;

FIG. 8 is a table for explaining calculation of awarded points based on densities;

FIG. 9 is a diagram for explaining generation of a planar graph;

FIG. 10 is a diagram for explaining extraction of representative routes;

FIG. 11 is a diagram for explaining extraction of representative routes;

FIG. 12 is a diagram for explaining combination of representative routes;

FIG. 13 is a diagram for explaining combination of representative routes;

FIG. 14 is a block diagram illustrating a schematic configuration of a computer that functions as a route graph generation device according to the first exemplary embodiment;

FIG. 15 is a flowchart illustrating an example of route graph generation processing according to the first exemplary embodiment;

FIG. 16 is a functional block diagram of a route graph generation device according to the second exemplary embodiment;

FIG. 17 is a diagram for explaining extraction of route collections;

FIG. 18 is a diagram illustrating an example of tracks;

FIG. 19 is a diagram for explaining route graph generation by optimization;

FIG. 20 is a block diagram illustrating a schematic configuration of a computer that functions a route graph generation device according to the second exemplary embodiment; and

FIG. 21 is a flowchart illustrating an example of a route graph generation processing according to the second exemplary embodiment.

### DESCRIPTION OF EMBODIMENTS

Detailed explanation follows regarding examples of exemplary embodiments of technology disclosed herein with reference to the drawings.

### First Exemplary Embodiment

In a first exemplary embodiment, a route graph displaying routes employed by route analysis is generated from track data indicating tracks moved along by moving bodies, without dividing a region into a mesh, and without employing road networks, map data, or the like. The track data is a sequence of position data indicating position-measured positions (position-measurement points) of moving bodies.

First, prior to explaining the first exemplary embodiment in detail, explanation follows regarding problems anticipated when generating a route graph from track data.

When a route graph is generated from track data, it is preferable to present collections of routes having high similarity to respective tracks represented in plural track data, and to generate a simple route graph. For example, generating a route graph by sequentially combining tracks having an inter-track distance from each other within a specific distance is conceivable.

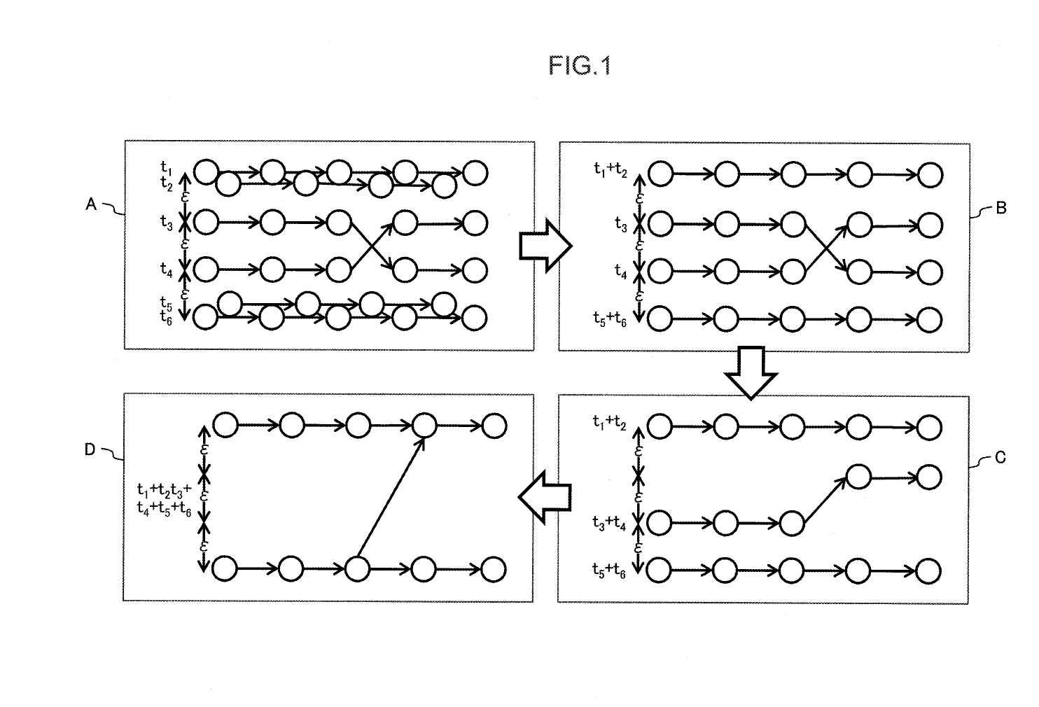

For example, explanation follows of an example case where respective tracks t₁ to t₆ illustrated in FIG. 1 are combined and a route graph generated. The white circle symbols in FIG. 1 represent position-measurement points included in respective tracks. Herein, when an inter-track distance is no more than ε, the tracks are combined by combining a position-measurement point of one of the tracks with a position-measurement point of the other track. For simplicity of explanation, the distance between the first half of track t₁ and the first half of track t₃, the distance between the second half of track t₁ and the second half of track t₄, the distance between the first half of track t₄ and the first half of track t₆, and the distance between the second half of track t₃ and the second half of track t₆ are set to ε. The distance between track t₁ and track t₂, and the distance between track t₅ and track t₆ are set distances shorter than ε.

In state A of FIG. 1, track t₁ and track t₂, and track t₅ and track t₆, having small inter-track distances, are respectively combined. Combining track t₂ into track t₁, and combining track t₅ into track t₆ gives state B of FIG. 1. Next, if track t₃ is examined, the distance thereof from track (t₁+t₂) is no more than ε for the first half of track t₃, however the distance is greater than ε for the second half of track t₃. However, since the distance from track t₄ is no more than ε across the entire range thereof, track t₃ is combined with track t₄. Combining track t₃ into track t₄ gives state C of FIG. 1. Note that even if track t₄ had been examined, although the distance thereof from track (t₅+t₆) is no more than ε for the first half of track t₄, since the distance is further than ε for the second half of track t₄, determination would be made to combine track t₃ and track t₄. Moreover, since the distance between the first half of track (t₃+t₄) and the first half of track (t₅+t₆), and the distance between the second half of track (t₃+t₄) and the second half of track (t₁+t₂) are no more than ε, these are combined, producing state D of FIG. 1. Since there are no portions present having an inter-track distance of no more than ε in state D of FIG. 1, track combination ends here, and state D of FIG. 1 is set as the route graph.

However, in the route graph generated as illustrated in D of FIG. 1, the flow in the original track t₃ from the track t₁ side to the track t₂ side is not displayed, and the route graph would not be considered a good approximation of all of the original tracks t₁ to t₆. This is thought to be a consequence of determining which of the other tracks to combine each respective track with based on inter-track distances alone, with a characteristic of the overall original track being lost in the sequential combination process.

In the first exemplary embodiment, the route graph is generated with additional consideration for the original track density, such that the overall characteristics of the original tracks are reflected in the route graph.

Explanation follows below regarding details of a route graph generation device according to the first exemplary embodiment.

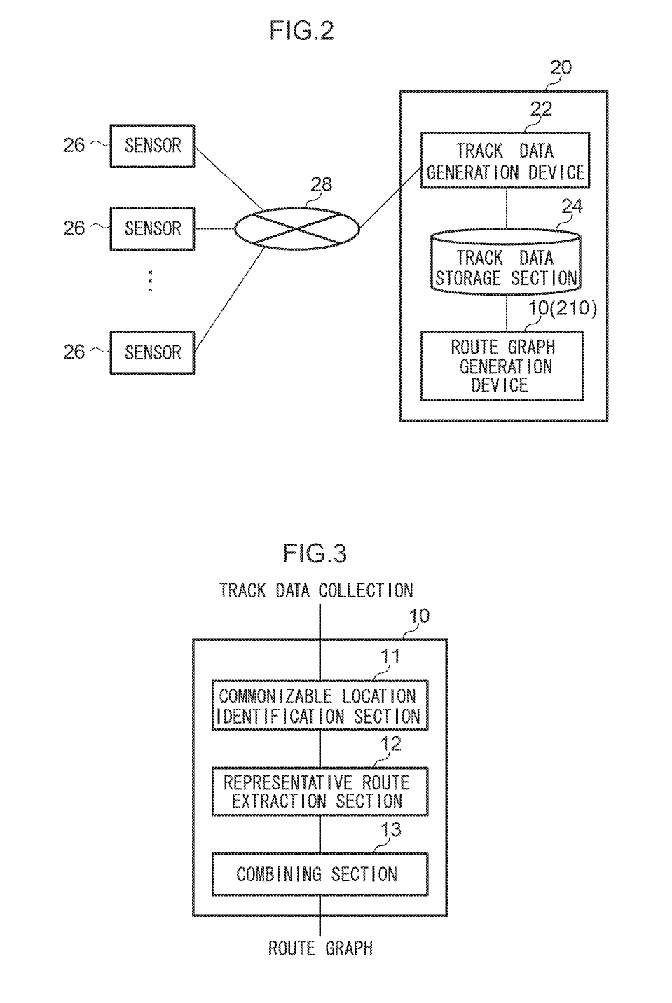

As illustrated in FIG. 2, a route graph generation device 10 according to the first exemplary embodiment is included in a route graph generation system 20, together with a track data generation device 22 and a track data storage section 24.

Through a network 28, the track data generation device 22 acquires position-measurement data indicating positions of moving bodies periodically position-measured by respective sensors 26 that position-measure positions of the moving bodies. The sensors 26 may be GPS or the like employed in a mobile phone carried by a person, a person being an example of a moving body, a terminal such as a smart phone, a car navigation system installed in a car, a car being an example of a moving body, or the like. The position-measurement data includes position data represented by a latitude and a longitude, time data indicating the position-measurement time, and a sensor ID that identifies the sensor 26. The track data generation device 22 extracts the plural acquired position-measurement data for each of the sensor IDs, and generates the track data by arranging the position data included in respective position-measurement data in a time sequence based on the time data. For example, if the position-measurement points indicated in position data included in the position-measurement data of a sensor having ID=k are pₖᵢ (i=1, 2, . . . , n; where n is the total number of position data items included in the position-measurement data that include the sensor having ID=k), then the track data representing track tₖ may be represented by tₖ=<pₖ₁, pₖ₂, . . . , pₖₙ>. The position data representing position-measurement point pᵢ is pᵢ=(xᵢ, yᵢ)εR² (R² is a 2-dimensional space having real numbers as elements).

The track data generation device 22 stores plural generated track data in the track data storage section 24. The track data storage section 24 may be a storage device provided to the track data generation device 22, or may be a storage device provided as an external device, separate from the track data generation device 22. The track data storage section 24 may be a portable storage medium such as a CD-ROM, DVD-ROM, or USB memory.

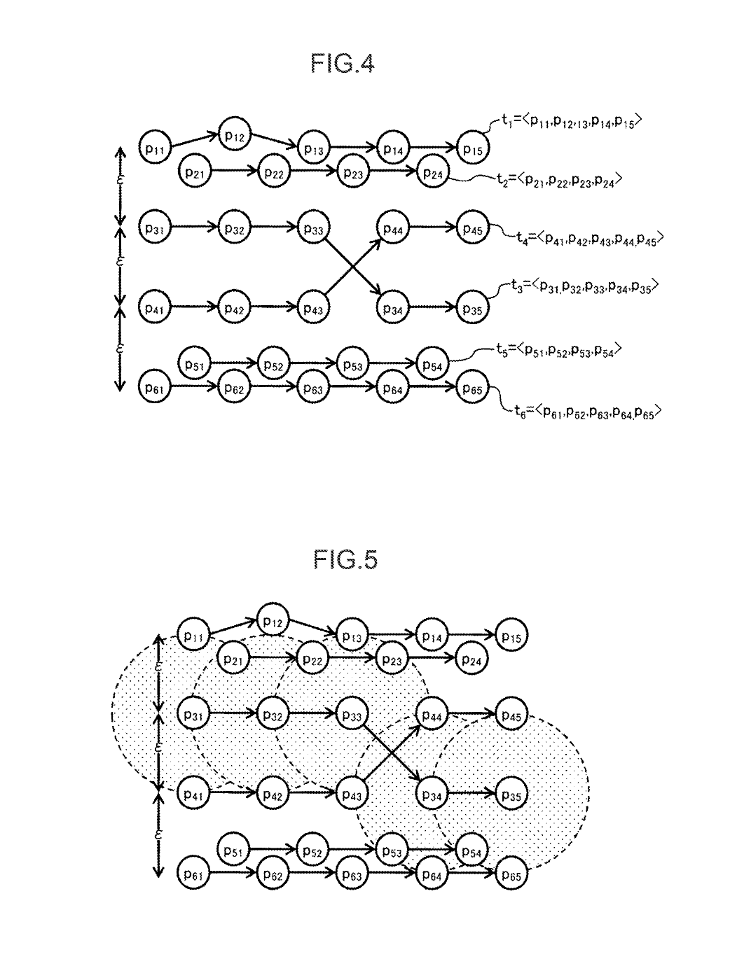

FIG. 3 illustrates a functional block diagram of the route graph generation device 10 according to the first exemplary embodiment. Track data collections stored in the track data storage section 24 are input to the route graph generation device 10. FIG. 4 illustrates an example of a schematic diagram of tracks representing respective track data included in the track data collection. In the example of FIG. 4, the track data representing the respective tracks t₁ to t₆ is included in the track data collection.

As illustrated in FIG. 3, the route graph generation device 10 includes a commonizable location identification section 11, a representative route extraction section 12, and a combining section 13. Detailed description follows below regarding each section of the route graph generation device 10. The commonizable location identification section 11 and the representative route extraction section 12 are examples of extraction sections of technology disclosed herein. The combining section 13 is an example of a generation section of technology disclosed herein.

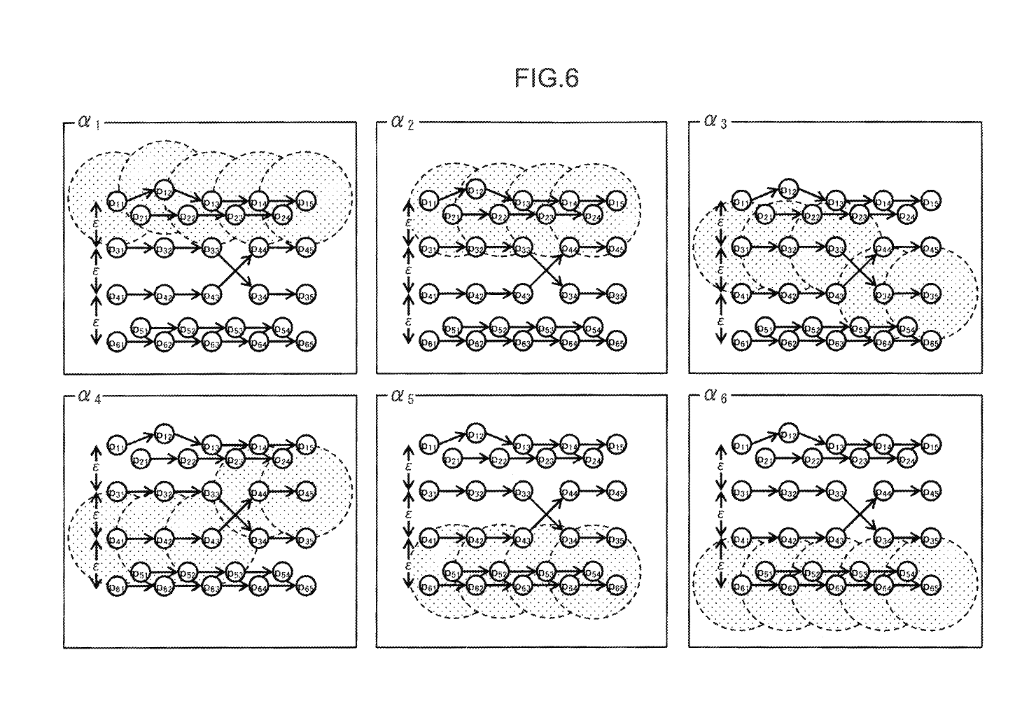

One by one, the commonizable location identification section 11 selects track data representing a processing-target track from the track data included in the input track data collection. The commonizable location identification section 11 identifies portions of another track present within a specific distance ε of the processing-target track as commonizable locations of the processing-target track and the other track. The Frechet distance, for example, may be employed as the inter-track distance. FIG. 5 illustrates an example of identified commonizable locations of the track t₃ and the other tracks. The range within the distance ε from the respective position-measurement points p₃ᵢ (i=1, 2, 3, 4, 5) of the track t₃ is indicated by the shaded circles bounded by dashed lines in FIG. 5. The commonizable location identification section 11 identifies the portions of other tracks included in this range as commonizable locations. Below, commonizable locations of each of the position-measurement points pₖᵢ of the respective tracks tₖ are denoted αₖᵢ, and collections of commonizable locations αₖᵢ are denoted αₖ. FIG. 6 illustrates a collection of shared locations αₖ identified for the respective tracks tₖ.

For each of the tracks tₖ, the commonizable location identification section 11 calculates awarded scores indicating densities of other tracks in the vicinities of the respective tracks. More specifically, the commonizable location identification section 11 sets a specific score value for the respective tracks tₖ, and apportions the set score values as assigned scores to the respective position-measurement points included in the given track tₖ. Then, the assigned score of the position-measurement points pₖᵢ are apportioned to other tracks identified as commonizable locations αₖᵢ for those position-measurement points pₖᵢ, and the apportioned assigned scores are then summed for the respective tracks and set as the awarded score indicating the density for that track.

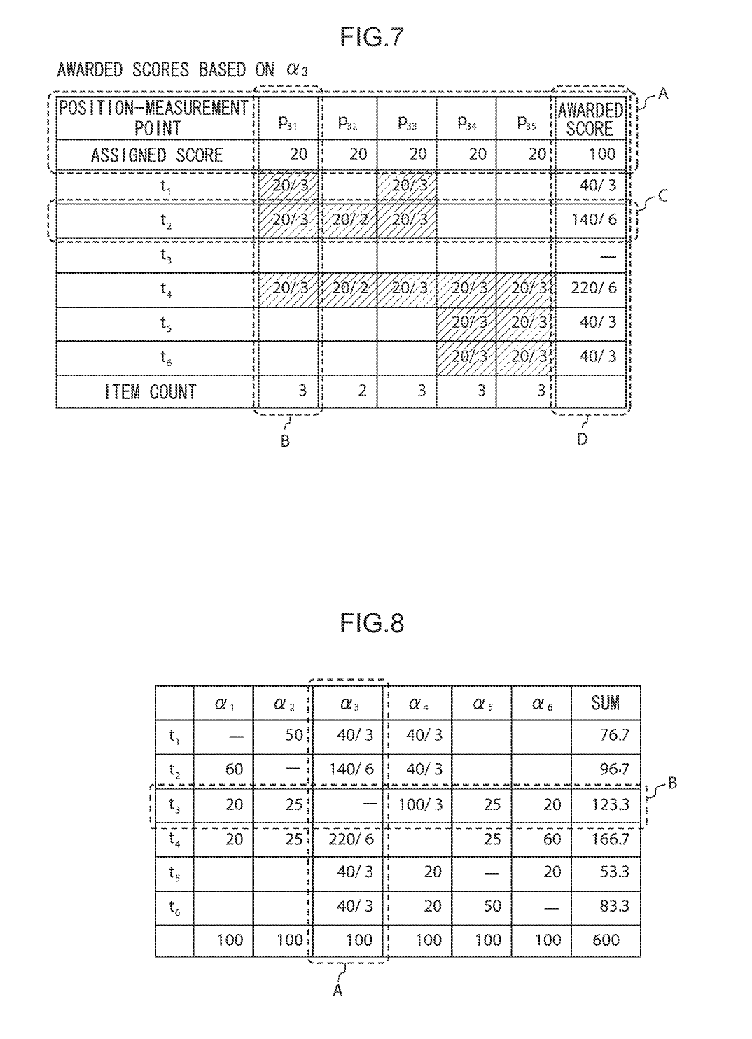

For example, if a score of 100 is the score value set for each track, since 5 position-measurement points are included in the track t₃, the commonizable location identification section 11 apportions an assigned score of 20 each to the respective position-measurement points p₃ᵢ of the track t₃ as illustrated at A in FIG. 7. As illustrated in FIG. 5, portions of the respective tracks t₁, t₂, and t₄ are identified as a commonizable location α₃₁ for the position-measurement point p₃₁. The commonizable location identification section 11 therefore apportions the assigned score of 20 of the position-measurement point p₃₁ to each of the tracks t₁, t₂, and t₄ as illustrated at B in FIG. 7. Similarly, the commonizable location identification section 11 also apportions the assigned scores for the commonizable locations α₃ᵢ of the other position-measurement points p₃ᵢ. In FIG. 7, the assigned scores apportioned to the respective tracks tₖ are denoted by the shaded cells. The commonizable location identification section 11 then calculates the total assigned score apportioned for each of the tracks tₖ (for example, the total for track t₂ is C of FIG. 7) as awarded scores based on the commonizable locations α₃.

Similarly, the commonizable location identification section 11 also calculates awarded scores based on the other commonizable locations αₖ, and calculates a sum of the awarded scores for each of the tracks tₖ based on the commonizable locations αₖ as illustrated in FIG. 8. The awarded score based on commonizable location α₃ illustrated by D in FIG. 7 corresponds to A in FIG. 8. Based on the commonizable locations αₖ of each of the tracks tₖ, the commonizable location identification section 11 calculates the sums of the awarded scores (for example, the sum for track t₃ is B in FIG. 8) as awarded scores representing the density of the respective tracks tₖ.

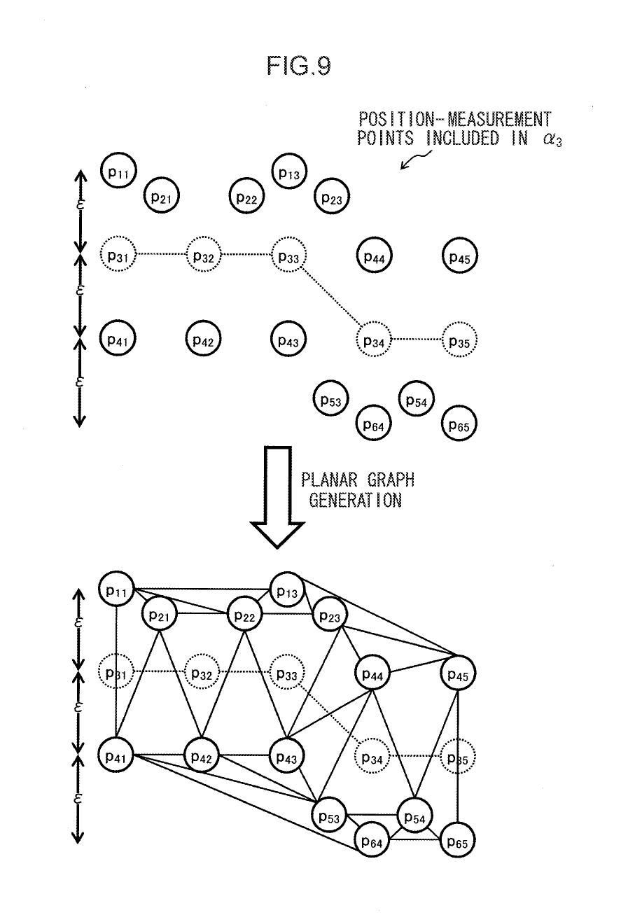

One by one, the representative route extraction section 12 selects track data as track data representing a processing-target track, and extracts a representative route corresponding to the processing-target track from the route connecting position-measurement points included in the commonizable locations of the processing-target track. More specifically, for the tracks tₖ (the track t₃ in the example of FIG. 9), the representative route extraction section 12 extracts only position-measurement points included in portions of the other tracks identified as the commonizable locations αₖ by the commonizable location identification section 11, as illustrated at the top of FIG. 9. Namely, for the commonizable locations, a state is produced in which edges connecting position-measurement points together have been removed. The track t₃ that is the processing-target track is indicated by the dashed line in FIG. 9.

As illustrated at the bottom of FIG. 9, the representative route extraction section 12 generates a planar graph in which the extracted position-measurement points are nodes. The planar graph may, for example, be generated by taking nodes corresponding to position-measurement points as generating points of a Voronoi diagram, and constructing a Delaunay graph connecting together the generating points that correspond to adjacent regions in the Voronoi diagram. The planar graph is not limited to a Delaunay graph, and another planar graph may be applied.

Out of the paths (routes) in the generated planar graph, the representative route extraction section 12 extracts a route having a high degree of matching with the processing-target track as the representative route based on node density and distance from the processing-target track. The degree of matching is defined so as to be higher for routes a shorter distance away from the track, and, in cases in which distances from the track are about the same, higher for routes passing through locations having higher node density. Routes common to other tracks included within the specific distance away from the processing-target track are thereby extracted as representative routes corresponding to the processing-target track.

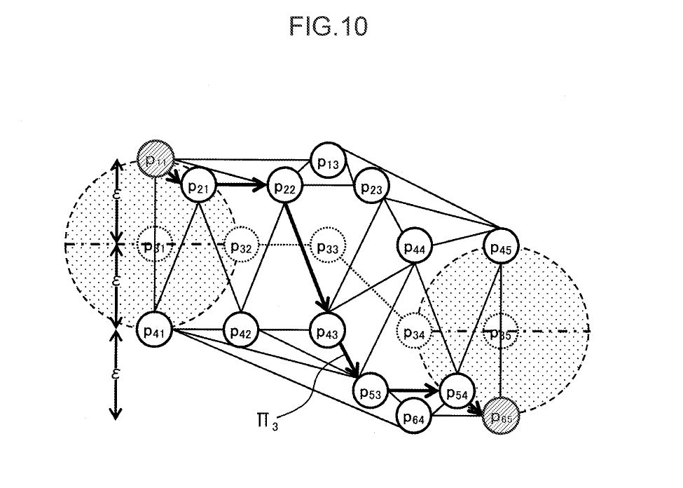

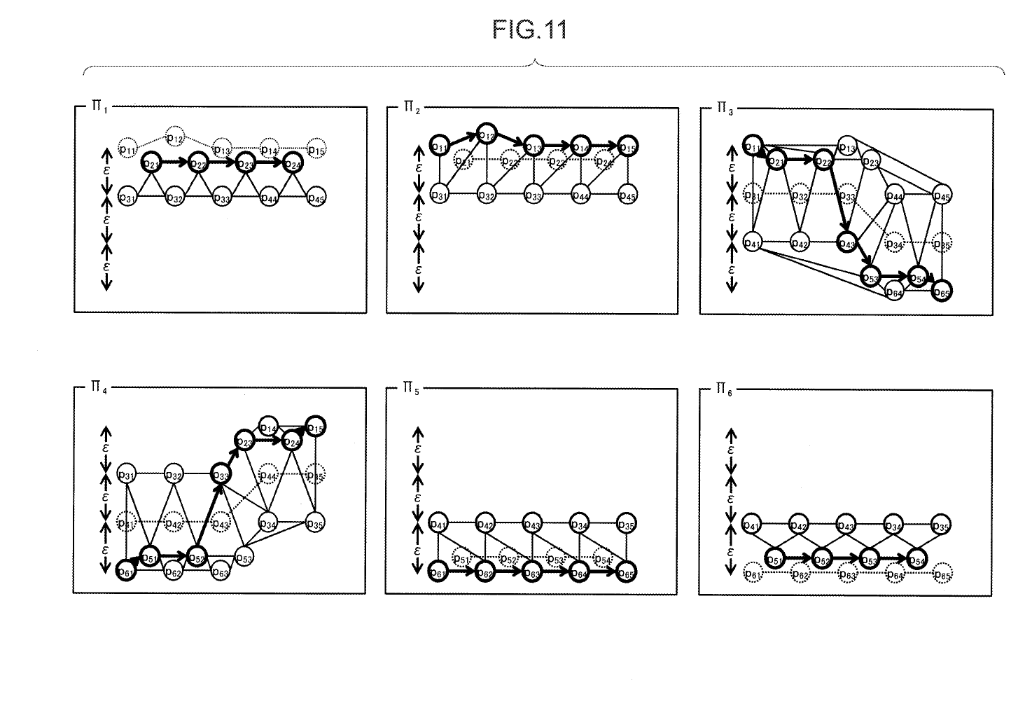

Explanation follows with reference to FIG. 10 regarding a case in which representative routes corresponding to the processing-target track t₃ are extracted from the planar graph. In the planar graph, the node corresponding to the position-measurement point pₖᵢ is denoted node pₖᵢ. FIG. 10 illustrates a planar graph generated from a commonizable location α₃ for the track t₃. The track t₃ that is the processing-target track is indicated by the dotted line in FIG. 10.

The representative route extraction section 12 searches for nodes of the planar graph included within the distance ε (the range within the dashed circle of a vicinity of the node p₃₁ in FIG. 10) from the node p₃₁ that is the start point of track t₃. In this case the nodes p₁₁, P₂₁ and p₄₁ are found. The representative route extraction section 12 divides the circle of distance ε from the node p₃₁ using a straight line passing through the starting point, node p₃₁, and the next point on the track t₃, node p₃₂ (a dotted-dashed line in FIG. 10), and selects from the two semicircles the semicircle that includes the most nodes. This thereby enables selection of the node having a high density within a vicinity of the node. In the example of FIG. 10, the upper semicircle is selected since there are two nodes included in the upper semicircle and one node included in the lower semicircle. The node the furthest distance away from node p₃₁ out of the nodes included in the selected semicircle (node p₁₁ here) is designated as the start point of the representative route being extracted.

Similarly for the node p₃₅ that is the termination point of the track t₃, the representative route extraction section 12 searches for nodes of the planar graph included within the distance ε from the node p₃₅ (the range within the dashed circle at a vicinity of the node p₃₅ in FIG. 10). In this case the nodes P₄₅, P₅₄, and p₆₅ are found. The representative route extraction section 12 divides the circle of distance ε from the node p₃₅ using a straight line passing through the termination point, node p₃₅, and the previous point on the track t₃, node p₃₄ (a dotted-dashed line in FIG. 10), and selects the semicircle that includes the most nodes from the two semicircles. The node the furthest distance away from node p₃₅ out of the nodes included in the selected semicircle (node p₆₅ here) is designated as the termination point of the representative route being extracted.

The representative route extraction section 12 searches for the path having the shortest distance (for example, Frechet distance) from the track t₃ out of paths in the planar graph in which the derived start point (node p₁₁) and the derived termination point (node p₆₅) are taken as the start point and termination point of the path. For example, the nodes p₂₁, P₁₃, and p₄₁ exist as candidates for the node following the node p₁₁, and of these, the node p₂₁, being the shortest distance away from the track t₃, is selected as the node following the node p₁₁. When plural nodes are present at the shortest distance away from the track t₃, the node having the highest density of nodes within a vicinity thereof is selected out of these nodes. Nodes having high density may be selected similarly to in the method of selecting the start point and termination point of the representative route. A specific number of nodes, ranked according to shortest distance away from the track t₃, may designed as candidates, and a node may be selected for inclusion in the representative route based on the density within a vicinity of each of these nodes. The representative route is selected by starting from the start point and repeating node selection in this manner until the termination point is reached. Below, the representative route corresponding to the track tₖ is denoted Πₖ.

The representative route extraction section 12 similarly extracts the representative routes Πₖ for the other tracks tₖ. FIG. 11 illustrates generated planar graphs, and extracted representative routes Πₖ for each of the tracks tₖ. Note that in FIG. 11, the processing-target tracks tₖ are indicated by paths connected by dotted lines, and the representative routes Πₖ are indicated by paths connected by bold lined arrows.

The combining section 13 ranks the respective representative routes corresponding to each of the tracks extracted by the representative route extraction section 12 according to the representative routes having the highest awarded score indicating the respective track densities calculated by the commonizable location identification section 11, and generates the route graph by combining with the route graph (temporary route graph) generated at that stage. The method of combination is to combine nodes of the processing-target representative route with nodes of the temporary route graph where the distance between nodes included in the representative route is no more than ε, similarly to in the method explained with reference to FIG. 1. A high awarded score for a representative route indicates a high density of other tracks in the track vicinity corresponding to that representative route, and such a representative route may be said to represent the characteristics of a greater number of tracks. Processing in sequence from such a representative route enables generation of a route graph that better represents the characteristics of the original tracks.

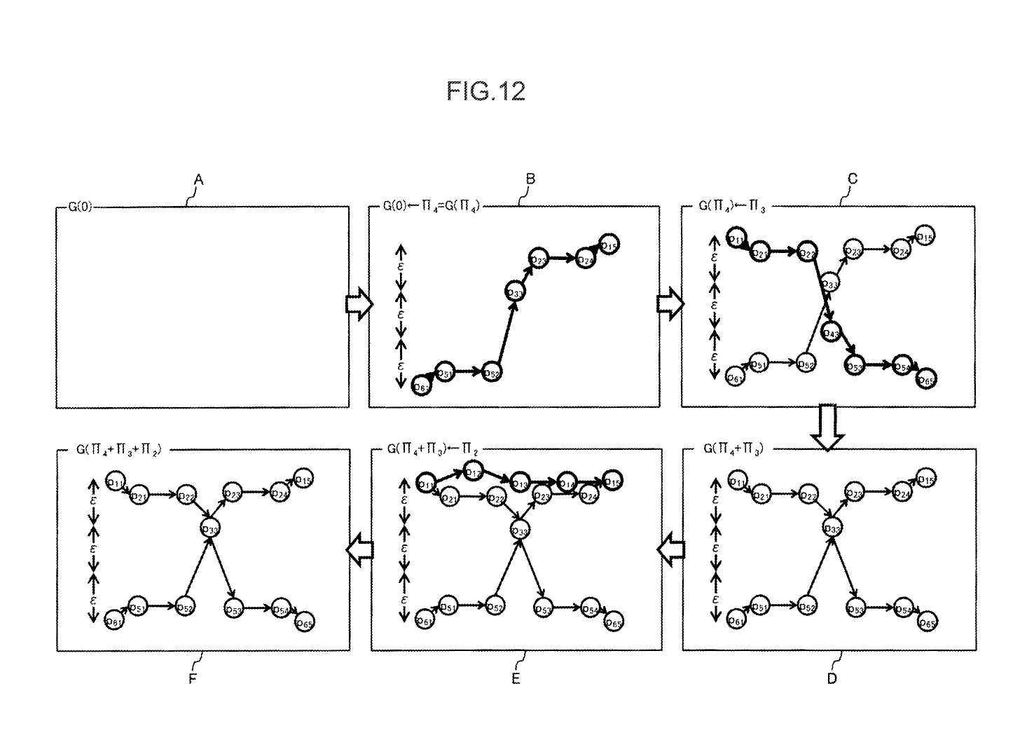

For example, consider a case in which the awarded scores indicating the densities for the respective tracks tₖ as illustrated in FIG. 8 are awarded by the commonizable location identification section 11. In this case, the combining section 13 processes in the sequence of representative routes Π₄→Π₃→Π₂→Π₆→Π₁→Π₅. More specifically, first, as illustrated in A of FIG. 12, the combining section 13 combines the initial processing-target representative route Π₄ with an empty temporary route graph G (0). In this case, as illustrated in B of FIG. 12, the representative route Π₄ becomes the temporary route graph G (Π₄) of this stage, without modification. Next, as illustrated in C of FIG. 12, the next representative route Π₃ is combined with the temporary route graph G (Π₄). Since the distance between the node p₃₃ and the node p₄₃ is no more than ε here, the node p₃₃ of the processing-target representative route Π₃ is combined with the node p₄₃ of the temporary route graph G (Π₄). As illustrated in D of FIG. 12, a temporary route graph G (Π₄+Π₃) is generated in which the representative route Π₃ is combined with the temporary route graph G (Π₄).

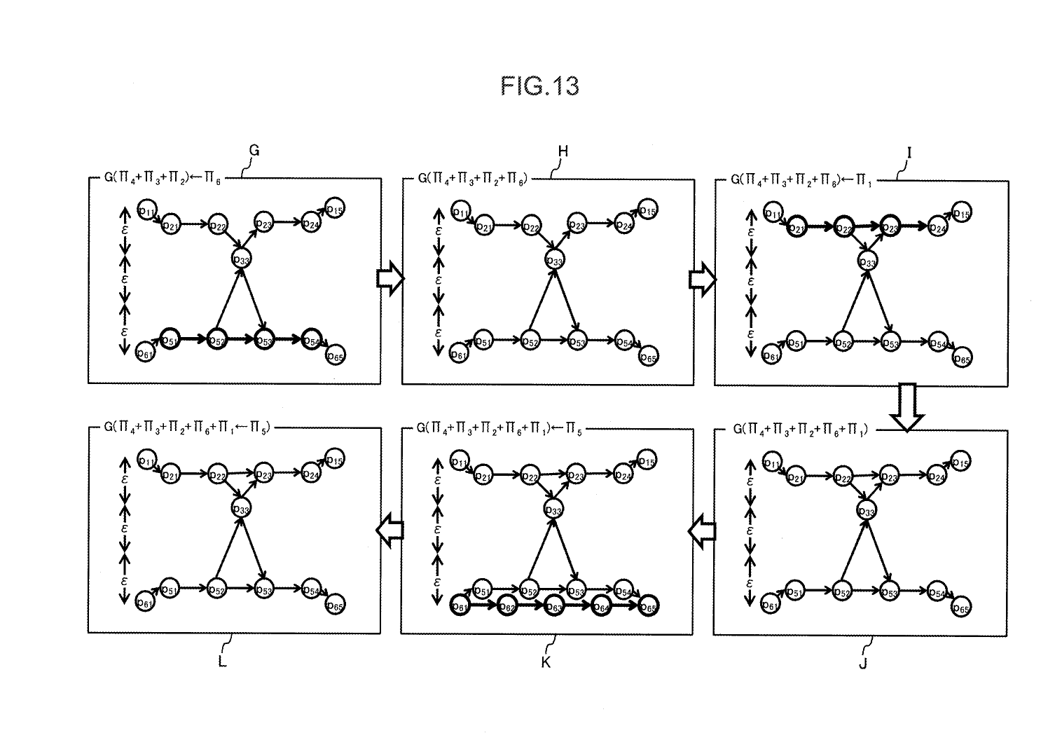

Similarly, as illustrated in E of FIG. 12, the representative route Π₂ is then combined with the temporary route graph G (Π₄+Π₃), and a temporary route graph G (Π₄+Π₃+Π₂) is generated such as that illustrated in F of FIG. 12. Then, as illustrated in G of FIG. 13, the representative route Π₆ is combined with the temporary route graph G (Π₄+Π₃+Π₂), and a temporary route graph G (Π₄+Π₃+Π₂+Π₆) is generated such as that illustrated in H of FIG. 13. Then, as illustrated in I of FIG. 13, the representative route Π₁ is combined with the temporary route graph G (Π₄+Π₃+Π₂+Π₆), and a temporary route graph G (Π₄+Π₃+Π₂+Π₆+Π₁) is generated such as that illustrated in J of FIG. 13. Then, as illustrated in K of FIG. 13, the representative route Π₅ is combined with the temporary route graph G (Π₄+Π₃+Π₂+Π₆+Π₁), and a temporary route graph G (Π₄+Π₃+Π₂+Π₆+Π₁+Π₅) is generated such as that illustrated in L of FIG. 13. Since there are no more unprocessed representative routes present at this stage, the temporary route graph G (Π₄+Π₃+Π₂+Π₆+Π₁+Π₅) is given as the final route graph G.

The combining section 13 outputs the generated route graph G=(V, E). Note that V is a collection of data representing nodes of the route graph, and E is a collection of data representing edges connecting nodes together.

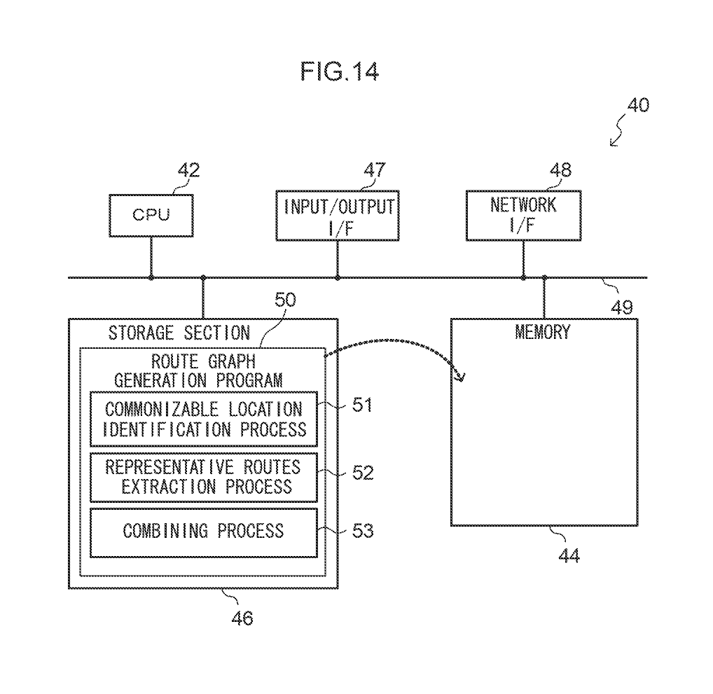

The route graph generation device 10 may be implemented by, for example, a computer 40, as illustrated in FIG. 14. The computer 40 includes a CPU 42, memory 44, a non-volatile storage section 46, an input/output interface (I/F) 47, and a network I/F 48. The CPU 42, the memory 44, the storage section 46, the input/output I/F 47, and the network I/F 48 are mutually connected through a bus 49.

The storage section 46 may be implemented by a hard disk drive (HDD), a solid state drive (SSD), a flash memory, or the like. The storage section 46, serving as a recording medium, stores a route graph generation program 50 that causes the computer 40 to function as the route graph generation device 10. The CPU 42 reads the route graph generation program 50 from the storage section 46, expands the route graph generation program 50 into the memory 44, and sequentially executes the processes included in the route graph generation program 50.

The route graph generation program 50 includes a commonizable location identification process 51, a representative route extraction process 52, and a combining process 53. The CPU 42 operates as the commonizable location identification section 11 illustrated in FIG. 3 by executing the commonizable location identification process 51. The CPU 42 operates as the representative route extraction section 12 illustrated in FIG. 3 by executing the representative route extraction process 52. The CPU 42 operates as the combining section 13 illustrated in FIG. 3 by executing the combining process 53.

Note that the route graph generation device 10 may also be implemented by a semiconductor integrated circuit, for example, more specifically by an Application Specific Integrated Circuit (ASIC) or the like.

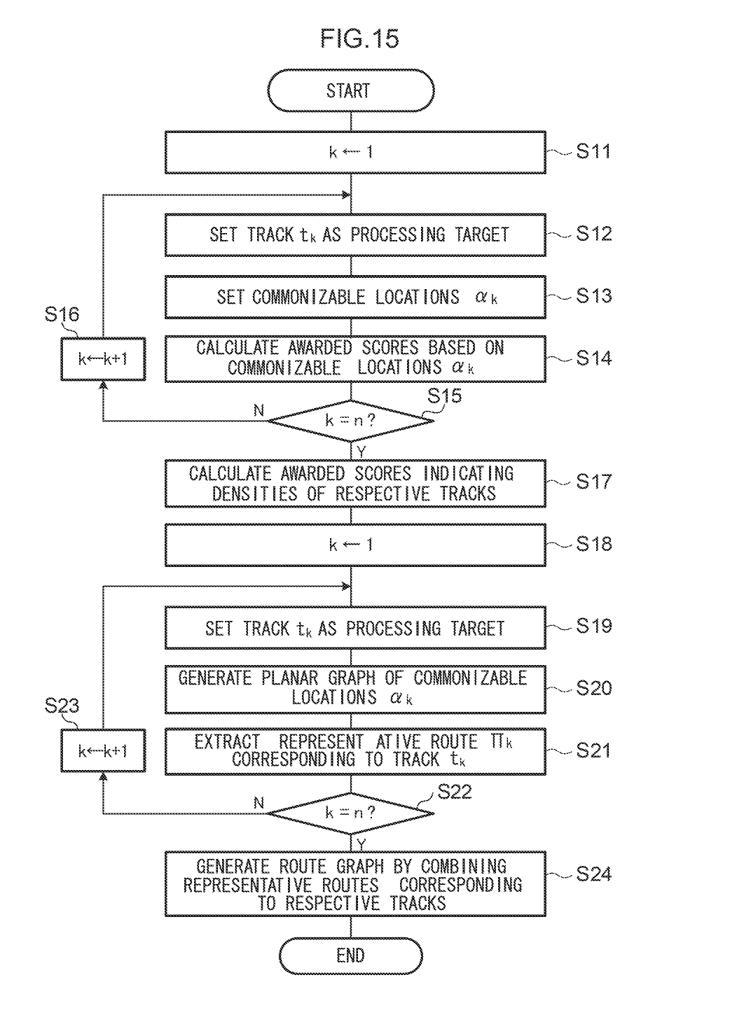

Next, explanation follows regarding operation of the first exemplary embodiment. The track data generation device 22 acquires position-measurement data position-measured by the plural respective sensors 26 through the network 28, generates track data from the position-measurement data, and stores the track data in the track data storage section 24. When track data collection stored in the track data storage section 24 is input to the route graph generation device 10, the route graph generation processing illustrated in FIG. 15 is executed in the route graph generation device 10.

At step S11 of the route graph generation processing illustrated in FIG. 15, the commonizable location identification section 11 sets the variable k to 1, and at the next step S12, sets the track tₖ as the processing-target. Next, at step S13 the commonizable location identification section 11 identifies portions of other tracks present within a specific distance ε from the processing-target track tₖ as commonizable locations αₖ.

Next, at step S14 the commonizable location identification section 11 apportions the specific score value set for the respective tracks tₖ to each of the position-measurement points pₖᵢ, included in that track tₖ, as assigned scores. Then, for each position-measurement point pₖᵢ, the commonizable location identification section 11 apportions the assigned scores of the position-measurement points pₖᵢ to other tracks identified as commonizable locations αₖ, for that position-measurement point pₖᵢ, and sums the apportioned assigned score for each of the tracks. The commonizable location identification section 11 thereby calculates awarded scores based on commonizable locations αₖ, for example, as illustrated in FIG. 7.

Next, at step S15 the commonizable location identification section 11 determines whether or not the variable k has reached the count n of the track data included in the track data collection. When k is less than n, processing transitions to step S16, the commonizable location identification section 11 increments k by 1, and processing returns to step S12. When k has reached n, processing transitions to step S17.

At step S17, the commonizable location identification section 11 for example, as illustrated in FIG. 8, sums the award points based on the commonizable locations αₖ calculated at step S14 above for the respective tracks tₖ, and calculates the awarded points that indicate the densities for the respective tracks tₖ.

Next, at step S18, the representative route extraction section 12 sets the variable k to 1, and at the next step S19, sets the track tₖ as the processing target. Next, at step S20, for the tracks tₖ, the representative route extraction section 12 removes the edges connecting together position-measurement points included in the portions of other tracks identified as the commonizable locations αₖ at step S13 above, and extracts the position-measurement points only. Then the representative route extraction section 12 generates a planar graph with the extracted position-measurement points as nodes.

Next, at step S21, out of paths in the planar graph generated at step S20 above, the representative route extraction section 12 extracts as a representative route Πₖ a path having a high degree of matching with the track tₖ, based on node density and distance away from the track tₖ.

Next, at step S22 the representative route extraction section 12 determines whether or not the variable k has reached the count n of track data included in the track data collection. When k is less than n, processing transitions to step S23, the representative route extraction section 12 increments k by 1, and processing returns to step S19. When k has reached n, processing transitions to step S24.

At step S24, from the representative routes corresponding to each of the tracks extracted at step S21 above, the combining section 13 selects the representative route, out of the unprocessed representative routes, that has the highest awarded score calculated at step S17 above indicating density of respective tracks. Then, the combining section 13 combines the selected representative route with the temporary route graph of that stage. The combining section 13 repeatedly performs the combination with the temporary route graph until there are no unprocessed representative routes present, and thereby generates the final route graph. The combining section 13 outputs the generated route graph G=(V, E), and the route graph generation processing ends.

As explained above, in the route graph generation device 10 according to the first exemplary embodiment, for each of the tracks represented by the track data, representative routes are extracted according to the degree they are commonizable with other tracks in the vicinity. The route graph is then generated by combining the representative routes corresponding to the respective tracks in sequence from the representative route having the highest density of other tracks in the track vicinity. Generation of a route graph that better represents the characteristics of the original tracks is thereby enabled, in contrast to cases in which the route graph is generated by combining together tracks simply is sequence by shortest distance apart from each other. Since the route graph is generated from the track data alone, difficulties caused by adjustments or the like of a mesh surface area do not arise, and an appropriate analysis result can be obtained when the route graph generated according to the first exemplary embodiment is employed in route analysis. Generating a route graph based on track data is also enabled for locations that do not correspond to a road network, map data, or the like, enabling appropriate analysis results to be obtained even for people moving freely.

Generating a planar graph having the position-measurement points included in the commonizable locations as nodes when the representative routes are extracted, enables efficient extraction of representative routes.

The density of other tracks in the track vicinity is calculated as an awarded score as described above, enabling densities to be derived by simple processing.

### Second Exemplary Embodiment

Next, explanation follows regarding a second exemplary embodiment. As illustrated in FIG. 2, a route graph generation device 210 according to the second exemplary embodiment is similarly included in a route graph generation system 20. In the route graph generation device 210 according to the second exemplary embodiment, sections similar to those of the route graph generation device 10 according to the first exemplary embodiment are appended with the same reference numerals, and detailed explanation thereof is omitted.

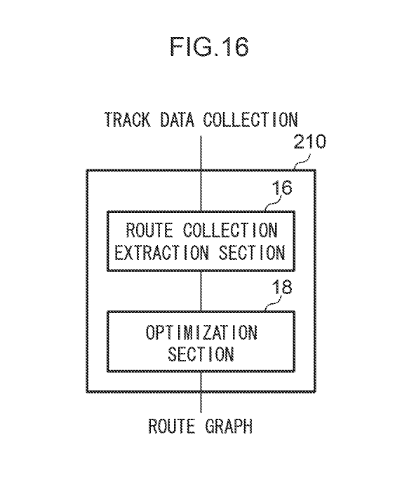

FIG. 16 illustrates a functional block diagram of the route graph generation device 210 according to the second exemplary embodiment. Similarly to in the first exemplary embodiment, the route graph generation device 210 is input with a collection of track data. The route graph generation device 210 includes a route collection extraction section 16, and an optimization section 17. The route collection extraction section 16 is an example of an extraction section of technology disclosed herein.

The route collection extraction section 16 maps the respective tracks represented by the track data onto network data including plural nodes and edges connecting nodes together. The network data may, for example, be a planar graph having position-measurement points, represented by the position-measurement data included in the track data of the input track data collection, as nodes. When road network data is usable, the road network data may also be employed. The route collection extraction section 16 extracts as routes to be employed in route graph generation, paths included in portions of network data that are present within a specific distance ε from tracks mapped onto the network data. The routes extracted for the tracks tₖ are denoted routes cₖᵢ (i=1, 2, . . . , n; where n is the total number of routes extracted for the track tₖ), and the routes cₖᵢ are collectively denoted route collection Sₖ.

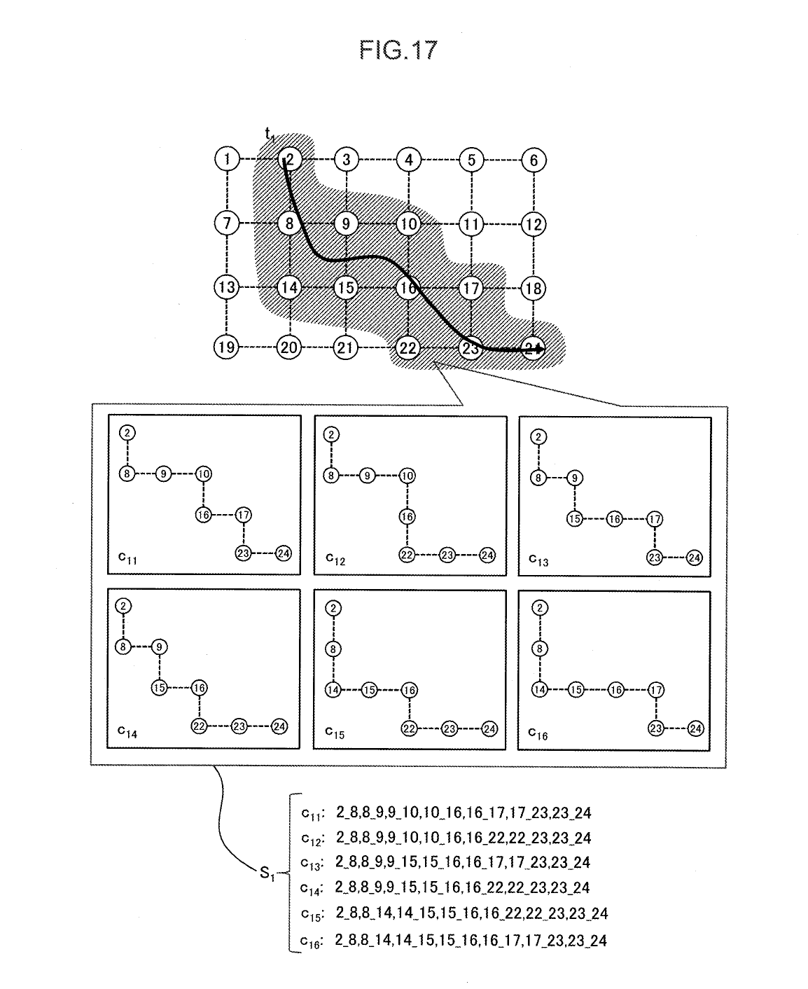

In order to simplify the explanation below, the network data is represented by a grid like that illustrated in FIG. 17 for example. In the example of FIG. 17, the white circle symbol is a node, numbers within the nodes are identifying numbers of the nodes (node IDs), and the inter-node dashed lines are the edges. For example, when a track t₁ is mapped onto this network data as illustrated in FIG. 17, the region shaded with diagonal lines in FIG. 17 is the region a distance ε from the track t₁. As illustrated in the center of FIG. 17, the route collection extraction section 16 extracts six routes, c₁₁ to c₁₆, from the region shaded with diagonal lines as the route collection S₁ for the track t₁. Routes are represented here as a series of edges, and the edges are denoted using the node IDs of the nodes at either end. For example, the route c₁₁ is expressed as follows:

c₁₁: 2_{—}8, 8_{—}9, 9_{—}10, 10_{—}16, 16_{—}17, 17_{—}23, 23_{—}24

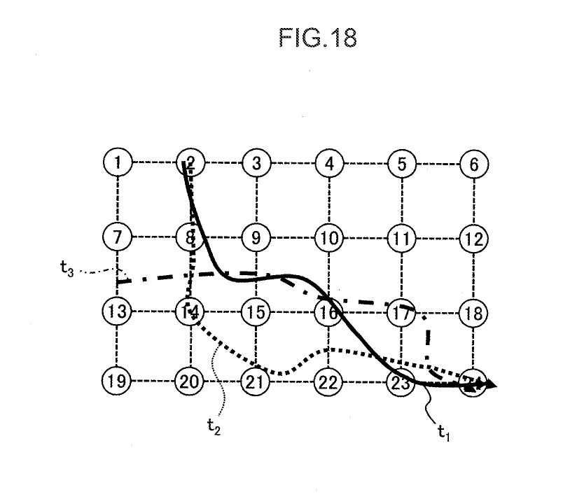

In order to simplify the explanation below, explanation follows in which the following route collections Sₖ are extracted for the respective tracks tₖ (k=1, 2, 3), as illustrated in FIG. 18.

S₁:

c₁₁: 2_{—}8, 8_{—}14, 14_{—}15, 15_{—}16, 16_{—}22, 22_{—}23, 23_{—}24

c₁₂: 2_{—}8, 8_{—}9, 9_{—}15, 15_{—}16, 16_{—}17, 17_{—}23, 23_{—}24

c₁₃: 2_{—}8, 8_{—}9, 9_{—}10, 10_{—}16, 16_{—}22, 22_{—}23, 23_{—}24

S₂:

C₂₁: 2_{—}8, 8_{—}14, 14_{—}20, 20_{—}21, 21_{—}22, 22_{—}23, 23_{—}24

c₂₂: 2_{—}8, 8_{—}14, 14_{—}15, 15_{—}21, 21_{—}22, 22_{—}23, 23_{—}24

c₂₃: 2_{—}8, 8_{—}14, 14_{—}15, 15_{—}16, 16_{—}22, 22_{—}23, 23_{—}24

S₃:

c₃ᵢ: 7_{—}8, 8_{—}9, 9_{—}10, 10_{—}16, 16_{—}17, 17_{—}23, 23_{—}24

c₃₂: 13_{—}14, 14_{—}15, 15_{—}16, 16_{—}17, 17_{—}23, 23_{—}24

The optimization section 17 generates a route graph by optimizing a combination of edges to be included in the route graph, out of the edges included in the route collections extracted by the route collection extraction section 16, so that the degree of similarity with the original tracks becomes higher.

The optimization section 17 performs the optimization, for example, as follows. First, the optimization section 17 sets the following constraints: (1) a route is a collection of edges; (2) tracks match one of the routes; (3) the route graph includes all of the routes matching the tracks. Then, under these constraints, the optimization section 17 performs optimization such that the number of edges included in the route graph is minimized.

For example, the optimization section 17 takes each of the edges included in the route collections Sₖ extracted by the route collection extraction section 16 as x, takes the routes cₖᵢ as y, and takes the routes matching the tracks tₖ as z, with each of these defined as follows. Note that routes matching the tracks are not only routes perfectly matching a track; routes matching a track with a degree of matching of a specific ratio or greater may also be included.

x2_{—}8, . . . , x23_{—}24ε{0, 1}

y₁₁, y₁₂, . . . , y₃₂ε{0,1}

z₁, z₂, z₃ε{0, 1}

The constraints (1) to (3) are defined as follows.

(1) A route is a collection of edges.

y₁₁:=x2_{—}8 [symbol] ×8_{—}14 [symbol] ×14_{—}15 [symbol] ×15_{—}16 [symbol] ×16_{—}22 [symbol] ×22_{—}23 [symbol] ×23_×24

y₁₂:=x2_{—}8 [symbol] ×8_{—}9 [symbol] ×9_{—}15 [symbol] ×15_{—}16 [symbol] ×16_{—}17 [symbol] ×17_{—}23 [symbol] ×23_×24

y₁₃:=x2_{—}8 [symbol] ×8_{—}9 [symbol] ×9_{—}10 [symbol] ×10_{—}16 [symbol] ×16_{—}22 [symbol] ×22_{—}23 [symbol] ×23_×24

and so on to

y₃₂:=x13_{—}14 [symbol] ×14_{—}15 [symbol] ×15_{—}16 [symbol] ×16_{—}17 [symbol] ×17_{—}23 [symbol] ×23_×24

(2) Tracks match one of the routes.

z₁:=y₁₁ [symbol] y₁₂ [symbol] y₁₃

z₂:=y₂₁ [symbol] y₂₂ [symbol] y₂₃

z₃:=y₃₁ [symbol] y₃₂

(3) The route graph includes all of the routes matching the tracks.

G=z₁̂z₂̂z₃

The optimization section 17 defines minimizing the number of edges included in the route graph by the following objective function.

minimize: x2_{—}8++x23_{—}24

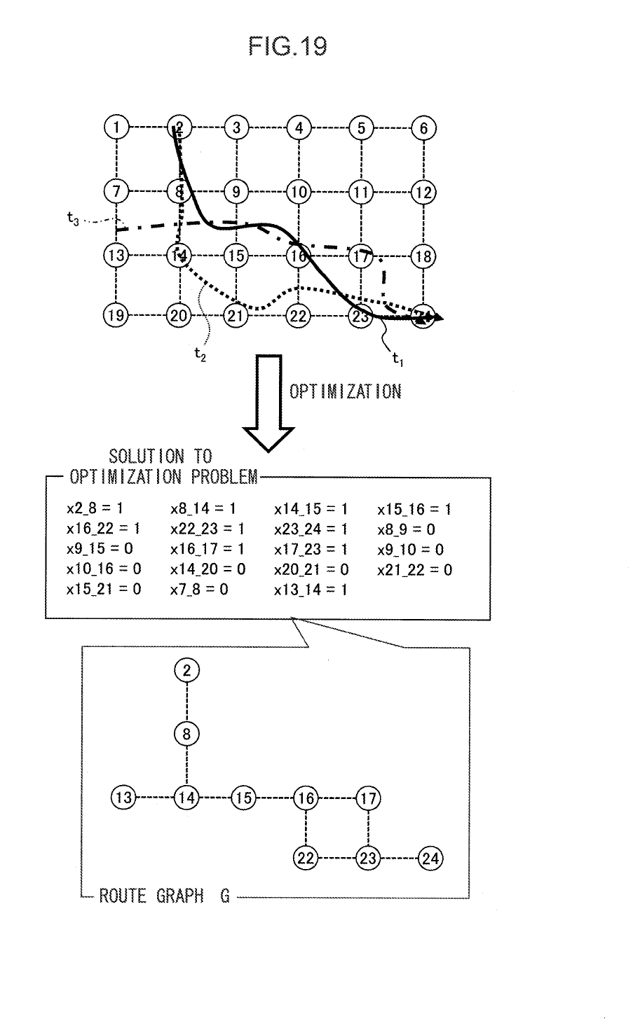

Under the constraints (1) to (3), the optimization section 17 reduces the objective function above to optimization of a 0-1 integer programming problem, and finds an optimized solution for x. Namely, an optimized solution is obtained wherein an x of 1 indicates that an edge is included, and an x of 0 indicates that an edge is not included in the route graph G. For example, an optimized solution such as that illustrated in the center of FIG. 19 is obtained for each edge included in the route collection Sₖ extracted by mapping the tracks tₖ (k=1, 2, 3), such as those illustrated at the top of FIG. 19, onto the network data. The optimization section 17 generates the route graph based on the obtained optimized solution and the network data. Specifically, connecting together edges corresponding to x values obtained as a value of 1 in the optimization solution enables generation of a route graph like that illustrated at the bottom of FIG. 19.

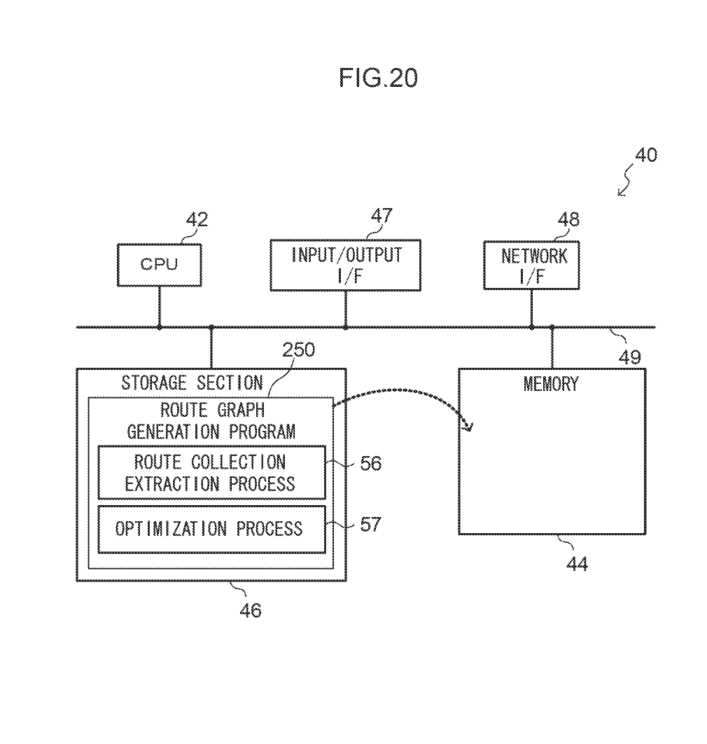

Similarly to the route graph generation device 10 according to the first exemplary embodiment, the route graph generation device 210 may, for example, be implemented by a computer 40 illustrated in FIG. 20. A storage section 46 of the computer 40 is stored with a route graph generation program 250 that causes the computer 40 to function as the route graph generation device 210. The CPU 42 reads the route graph generation program 250 from the storage section 46, expands the route graph generation program 250 into memory 44, and sequentially executes the processes included in the route graph generation program 250.

The route graph generation program 250 includes a route collection extraction process 56, and an optimization process 57. The CPU 42 operates as the route collection extraction section 16 illustrated in FIG. 16 by executing the route collection extraction process 56. The CPU 42 operates as the optimization section 17 illustrated in FIG. 16 by executing the optimization process 57.

Note that the route graph generation device 210 may also be implemented by a semiconductor integrated circuit, for example, more specifically by an ASIC or the like.

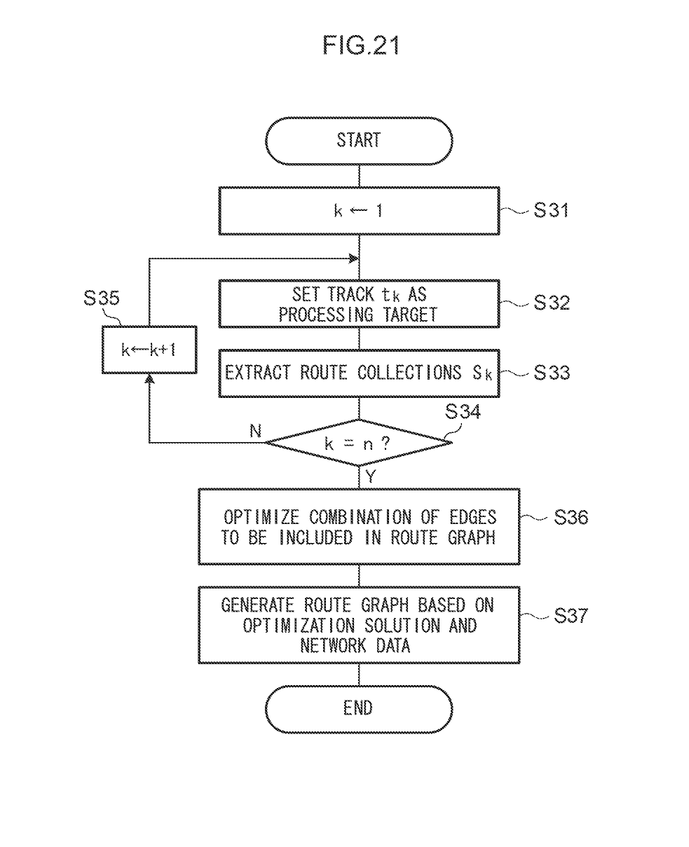

Next, explanation follows regarding operation of the second exemplary embodiment. In the second exemplary embodiment, the route graph generation processing illustrated in FIG. 21 is executed in the route graph generation device 210.

At step S31 of the route graph generation processing illustrated in FIG. 21, the route collection extraction section 16 sets a variable k to 1, and at the next step S32, sets the track tₖ as the processing target.

Next, at step S33, the route collection extraction section 16 maps the track tₖ onto the network data. Then, the route collection extraction section 16 extracts route collections Sₖ included in portions of the network data that are present within the specific distance ε from the track mapped onto the network data.

Next, at step S34 the route collection extraction section 16 determines whether or not the variable k has reached the count n of the track data items included in the track data collection. When k is less than n, processing transitions to step S35, the route collection extraction section 16 increments k by 1, and processing returns to step S32. When k has reached n, processing transitions to step S36.

Next, at step S36 the optimization section 17 sets the following constraints: (1) a route is a collection of edges; (2) tracks match one of the routes; (3) the route graph includes all of the routes matching the tracks. Then, under these constraints, the optimization section 17 finds an optimized solution indicating edges included in the route graph by, for example, solving optimization of a 0-1 integer programming problem like that above, such that the number of edges included in the route graph is minimized.

Next, at step S37 the optimization section 17 generates the route graph G based on the optimized solution obtained at step S36, and the network data employed at step S33. The optimization section 17 outputs the generated route graph G, and route graph G generation processing ends.

As explained above, in the route graph generation device 210 according to the second exemplary embodiment, the tracks are mapped onto the network data, and the route collection is extracted from the portions of the network data included in a range within a specific distance away from the tracks. Then, a route graph is generated by optimizing combinations of edges to be included in the route graph, out of the edges included in the route collection, such that the number of edges included in the route graph is minimized. Generation of a route graph that well represents the characteristics of the original tracks is therefore enabled.

In the second exemplary embodiment, although a route graph is generated from the track data and the network data alone, this network data may employ a planar graph generated from the track data. Accordingly, similarly to the first exemplary embodiment, difficulties caused by adjustments or the like of a mesh surface area do not arise, and an appropriate analysis result can be obtained when the route generated by the second exemplary embodiment is employed in route analysis. Generating a route graph based on track data is also enabled for locations that do not correspond to a road network, map data, or the like, enabling appropriate analysis results to be obtained even for people moving freely.

Explanation has been given above in which the route graph generation programs 50, 250, that are examples of route graph generation programs according to technology disclosed herein, are stored in advance (installed) in the storage section 46; however, there is no limitation thereto. The route graph generation program according to technology disclosed herein may also be provided in a format recorded on a storage medium such as a CD-ROM, DVD-ROM, or USB memory.

In route analysis employing a mesh, analysis results sometimes change according to the size of the set surface area of the mesh. For example, when the surface area of the mesh is small, substantially similar track data sometimes appear as different routes. When the surface area of the mesh is large, different track data intended to be handled as a different route sometimes appears as the same route. Minor variations in mesh surface area adjustments of this type sometimes have a detrimental impact on analysis results. At the partitioning regions of the mesh, even for position-measurement points representing substantially similar places, sometimes one position-measurement point will be associated with one mesh square, and another position-measurement point will be associated with another mesh square on the other side of a boundary, and sometimes appropriate analysis results cannot be obtained.

An advantageous effect of one aspect of technology disclosed herein is enabling generation of a route graph enabling appropriate analysis results to be obtained from route analysis.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A route extraction method, comprising:
by a processor, when extracting, for combination with an identified route out of a plurality of routes, a route from the other routes in the plurality of routes, performing control that increases extraction probability according to distribution density of the other routes.

2. The route extraction method of claim 1, wherein, when there is a first route and a second route present within a specific distance away from the identified route, the first route is extracted when a route distribution density in a vicinity of the first route is higher than a route distribution density in a vicinity of the second route.

3. The route extraction method of claim 1, wherein the route distribution density is calculated based on a distribution density of nodes within the routes.

4. A route graph generation method, comprising:
by a processor, for a plurality of respective track data representing a series of points indicating positions of moving bodies, extracting a representative route from routes connecting together points of other tracks that are within a specific distance away from a track represented by processing-target track data, based on distances from the processing-target track and based on densities of points; and
generating a route graph based on a plurality of representative routes extracted for each of the tracks.

5. The route graph generation method of claim 4, wherein the route graph is generated by combining each of the plurality of representative routes extracted for each of the tracks with a temporary route graph, based on distances from the temporary route during generation, in sequence from a representative route having a highest density of other tracks in a track vicinity corresponding to the representative route.

6. The route graph generation method of claim 4, wherein:
a planar graph is generated having, as nodes, the respective points of other tracks present within the specific distance as the representative routes; and
out of paths in the planar graph, a path having a highest degree of matching is extracted, wherein the degree of matching is higher the shorter the distance is to the processing-target track and the higher the density of nodes is in the vicinity of a node to be selected.

7. The route graph generation method of claim 4, wherein the density of other tracks in the track vicinity corresponding to the representative route is indicated by an awarded score from distributing a set score value to each of the tracks as an assigned score for each of the points included in the track, and summing the assigned scores distributed to points of other tracks present within the specific distance away from the processing-target track.

8. A route graph generation method, comprising:
by a processor, mapping each track, represented by a plurality track data each representing a series of points indicating positions of a moving body, onto network data including a plurality nodes and edges that connect the nodes together, and extracting as a route any paths in the network data present within a specific distance away from each of the tracks; and
generating a route graph by finding, from out of edges included in the extracted plurality of routes, a combination of edges to be included in the route graph optimized such that similarity of the combination of edges to the plurality of tracks becomes higher.

9. The route graph generation method of claim 8, wherein, during the optimization, the count of edges included in the route graph is minimized under the following constraints: the extracted routes are collections of edges, each of the tracks corresponds to one of the extracted routes, and the route graph includes all of the routes corresponding to the tracks.

10. The route graph generation method of claim 8, wherein the network data is a planar graph having, as nodes, points included in the plurality of track data.
